(19) United States
(12) Patent Application Publication
(10) Pub. No.: US 2006/0175429 A1
(43) Pub. Date: Aug. 10, 2006

(54) Fire fighting system

(76) Inventors: John J. Lanigan JR., New Lenox, IL (US); William P. Lanigan, Orland Park, IL (US); Myron Glickman, Arlington Heights, IL (US); Barry Tutin, Tinley Park, IL (US)

Correspondence Address: George H. Gerstman;SEYFARTH SHAW LLP, 55 East Monroe Street, Chicago, IL, 60603, US

(21) Appl. No.: 11/299,866

(22) Filed: Dec. 12, 2005

Related U.S. Application Data
(60) Provisional application No. 60/650,335, filed on Feb. 4, 2005.
(60) Provisional application No. 60/697,261, filed on Jul. 7, 2005.

(51) Int. Cl. B64D 1/18; A62C 25/00

(52) U.S. Cl. 239/171; 169/53; 169/30

(57) ABSTRACT

A firefighting system including a helicopter and a housing defining a receptacle for storing a fire suppressant material removably connectable to the helicopter. At least one cannon connected to the housing where the cannon is automatically extendable from the housing. The helicopter transports the housing to a location of a fire. The cannon is extended from the housing and is operable to emit at least a portion of the fire suppressant material on a fire. The firefighting system may also include a housing sized to transport at least one person trapped by a fire from the building to a safe location.

### PRIORITY CLAIM

This application claims priority to and the benefit of U.S. Provisional Application Ser. No. 60/650,335, filed Feb. 4, 2005, and U.S. Provisional Application Ser. No. 60/697,261, filed Jul. 7, 2005, the entire contents of which are incorporated herein.

### BACKGROUND

Fires in high rise buildings cause significant loss of life and millions of dollars in damage. Such loss and damage is primarily due to the difficulties associated with fighting and controlling fires in these buildings. Specifically, the height of high rise buildings poses unique challenges to firefighters and significantly limits key firefighting strategies.

Typically in high rise building fires, people become trapped on higher floors because fires on lower floors prevent a safe exit from the building. Unfortunately, rescuing people trapped by a high rise fires using ladders is virtually eliminated because the ladders are too short to reach the higher floors. Furthermore, in some situations, people trapped in these fires cannot wait to be rescued due to the extreme heat and smoke generated by the fire and therefore have no choice but to jump from the high rise building.

High-rise buildings also minimize, if not eliminate, the ability of firefighters to extinguish a fire with an outside water stream because the water streams can only reach a limited distance above the ground. As a result, other fire extinguishing means must be used to fight high rise fires.

One strategy used by firefighters to attack a high rise fire and to rescue people trapped by the fire is to attack the fire from within the high rise building. In these situations, firefighters use internal stairways to access a fire and attempt to extinguish the fire using hoses while moving through substantial heat and smoke. However, this strategy is both time-consuming and dangerous to firefighters.

Another strategy is to use helicopters to assist with high rise fires. Helicopters are sometimes used to rescue people trapped on the higher floors using baskets or stretchers attached to a rope or cable which is lowered down to the trapped people. However, such efforts are very difficult to coordinate due to inclement weather conditions, wind conditions and the location of the trapped people. Furthermore, helicopters are generally not able to help fight high rise fires by dropping water on the fires, such as with forest fires, due to the configuration and congested location of high rise buildings. As a result, helicopters are typically not used to fight these types of fires.

High rise fires pose several challenges for firefighters because these fires are difficult to access, control and eliminate, and significantly limit the firefighting equipment and techniques available to firefighters for fighting these fires.

Accordingly, there is a need for a firefighting system which enables firefighters to quickly and efficiently control and eliminate high rise fires and safely rescue people trapped by these fires.

### SUMMARY

The present invention is directed to a firefighting system and, more specifically, to an apparatus, method and system for fighting high rise fires including an interchangeable container transportable by a helicopter to a location of a fire to help fight the fire and rescue people trapped by the fire.

One embodiment of the present invention provides a firefighting system including a helicopter, a securing mechanism connected to the helicopter and a housing defining a receptacle for storing a fire suppressant material. The housing includes a plurality of securing devices, each of the securing devices being engageable by the securing mechanism to secure the housing to the helicopter for transport to a location of a fire such as in a high rise building. At least one cannon is connected to the housing. The cannon is automatically extendable from the housing and operable to emit at least a portion of the fire suppressant material on the fire.

In an embodiment, the cannon includes a plurality of telescoping sections to provide the extendability feature of the cannon.

In another embodiment, the cannon is automatically coupled to the housing when the housing is connected to the helicopter. This operation minimizes the amount of time associated with securing the containers or housings to the helicopter which is critical in fighting fires.

In an embodiment, the fire suppressant material includes at least one of the materials selected from the group consisting of: water and halon gas.

In another embodiment, the system includes a suction device or snorkel connected to the housing. The suction device is operable to transport a fire suppressant material from a source of the fire suppressant material to the housing.

In a further embodiment, the system includes a door movably connected to a bottom surface of the housing, wherein the door is operable to move between a closed position and a substantially open position to enable the fire suppressant material stored in the housing to be dropped onto the fire.

In an embodiment, the helicopter includes at least one actuator in communication with the housing. The actuator is operable to adjust at least one of the extension, elevation and azimuth of the cannon.

In another embodiment, the system includes at least one sensor connected to the helicopter. The sensor is operable to determine a plurality of operational parameters associated with the helicopter. In this embodiment, the sensor includes at least one of the sensors selected from the group consisting of: a force transducer, an accelerometer and a gyroscopic device.

In an embodiment, the system includes a plurality of housings, where each of the housings defines a receptacle for storing a fire suppressant material. Each of the housings are also engageable by the securing mechanism to interchangeably secure each of the housings to the helicopter for transport to the location of the fire.

Another embodiment of the present invention provides a firefighting system including a helicopter, a securing mechanism connected to the helicopter and a housing including a cannon. The housing includes a plurality of securing devices, where each of the securing devices is engageable by the securing mechanism to secure the housing to the helicopter for transport to a location of a fire. At least one canister is stored in the housing. The canister includes a fire suppressant material, where the cannon is operable to eject the canister from the housing to the location of the fire.

In an embodiment, the housing includes a plurality of cannons. Each of the cannons are operable to eject one of a plurality of canisters stored in the housing.

In another embodiment, the system includes a solid propellant connected to the canister to propel the canister from the housing via the cannon.

In an embodiment, the cannon includes a plurality of telescoping sections to provide the extendability feature of the cannon.

In another embodiment, the helicopter includes at least one actuator in communication with the housing. The actuator is operable to adjust at least one of the extension, elevation and azimuth of each of the cannons.

In an embodiment, the system includes a plurality of housings. Each of the housings including at least one extendable cannon and a plurality of canisters containing a fire suppressant material. The housings are each engageable by the securing mechanism to interchangeably secure each of the housings to the helicopter for transport to the location of the fire.

A further embodiment of the present invention provides a firefighting system including a helicopter, a securing mechanism connected to the helicopter and a housing adapted to hold at least one person. The housing includes a plurality of securing devices, where each of the securing devices is engageable by the securing mechanism to secure the housing to the helicopter for transport to a location of a fire.

In an embodiment, at least one door is movably connected to the housing to enable the person to access the housing.

In another embodiment, a ramp is connected to the housing. The ramp is positioned adjacent to the door and operable to automatically extend from the housing to enable the person to move from the location of the fire to the housing. The ramp is constructed to support the weight of the person.

In an embodiment, the ramp includes a plurality of telescoping sections, where each of the sections includes a platform and a handrail to provide support for the person moving from the location of the fire to the housing.

In another embodiment, the system includes at least one counterweight connected to the housing. The counterweight being automatically extendable from a side of the housing opposite to the side including the ramp to counteract a moment generated by the weights of the person and the ramp.

In an embodiment, the housing is adapted to hold a plurality of people, where the ramp is constructed to support at least the combined weight of the people moving on the ramp from the location of the fire to the housing.

In another embodiment, the system includes at least a first counterweight movably connected to the housing. The first counterweight is operable to automatically extend a distance from the housing to counteract a moment generated by the combined weight of the ramp and the person.

In an embodiment, a second counterweight is connected to one of the housing and the first counterweight to counteract the moment generated by the combined weight of the ramp and the person.

In another embodiment, the system includes at least one force sensor connected to the helicopter. The force sensor operable to calculate the moment created by the weight of the ramp and the person, wherein the first counterweight is automatically extended from the housing based on the moment calculated by the sensor.

In an embodiment, the system includes an extendable canopy connected to the ramp. The canopy is adapted to protect the person moving on the ramp from falling debris generated by the fire.

In another embodiment, the housing includes emergency medical equipment used to treat a person injured by the fire.

In a further embodiment, the system includes at least one generator coupled to the helicopter. The generator is operable to generate electricity for the housing, where the housing is automatically coupled to the generator when the housing is connected to the helicopter.

In an embodiment, the housing is adapted to be secured to a truck to transport any injured people from the location of the fire to an emergency medical facility.

Another embodiment of the present invention provides a method of operating a firefighting system. The method includes securing a container to a helicopter having a securing mechanism and at least one control mechanism. The container includes a plurality of securing devices, where each of the securing devices is engageable by the securing mechanism to secure the housing to the helicopter for transport to a location of a fire. The method includes automatically coupling the control mechanism to the container, where the control mechanism is operable to communicate with the container and control a function of the container. The method also includes transporting the container to a location of a fire.

In an embodiment, the method includes automatically extending a cannon connected to the housing. The cannon is operable to emit a fire suppressant material stored in the container on the fire.

In another embodiment, the function includes ejecting a canister containing a fire suppressant material from a cannon connected to the container to the location of the fire.

In a further embodiment, the function includes automatically extending a walkway movably connected to the housing. The housing is adapted to hold at least one person. The walkway is adapted to support the weight of the person.

In an embodiment, the method includes automatically extending a first counterweight from a side opposite to the side of the housing including the walkway. The first counterweight is automatically extended from the housing based on a distance the walkway is extended from the housing.

In another embodiment, the method includes automatically extending a second counterweight from the housing based on the distance that the first counterweight and the walkway are extended from the housing.

It is therefore an advantage of the present invention to provide a firefighting system and apparatus which helps firefighters suppress and control fires in high places.

Another advantage of the present invention is to provide a firefighting system and apparatus which is used to safely rescue one or more people trapped by fires in high places.

It is a further advantage of the present invention to provide a firefighting system and apparatus which quickly and efficiently suppresses and controls fires in high places.

It is another advantage of the present invention to provide a firefighting system and apparatus which minimizes firefighters risk of injury and death due to fires in high places.

It is a further advantage of the present invention to provide a firefighting system and apparatus which employs interchangeable containers that are easily transportable by a helicopter or other vehicle to the location of a fire or other disaster.

Other objects, features and advantages of the invention will be apparent from the following detailed disclosure, taken in conjunction with the accompanying sheets of drawings, wherein like numerals refer to like parts, elements, components, steps and processes.

### DESCRIPTION OF THE FIGURES

FIG. 1 is a perspective view of a helicopter carrying a container according to one embodiment of the present invention.

FIG. 2A is a perspective view of the embodiment of the container illustrated in FIG. 1.

FIG. 3A is a front view of one embodiment of a latch connected to the container shown in FIG. 2A.

FIG. 3B is a cross section view of the latch taken substantially along line 3B-3B in FIG. 3A.

FIG. 4 is a perspective view of a wedge utilized by a securing mechanism connected to the helicopter to engage and hold the container shown in FIG. 2A.

FIG. 5 is a perspective view of another embodiment of the present invention where the container includes a suction member.

FIG. 6 is a perspective view of a helicopter carrying a container according to another embodiment of the present invention where the container includes fire suppressant canisters.

FIG. 7 is a perspective view of the container shown in FIG. 6.

FIG. 8 is a diagrammatic view of a canister included in the container of FIG. 7.

FIG. 9A is a side view of a helicopter carrying a container according to another embodiment of the present invention where the container is used to transport people rescued from a fire.

FIG. 9B is a front view of the embodiment illustrated in FIG. 9B.

FIG. 10 is a perspective view of a helicopter carrying a container according to a further embodiment of the present invention where the container is used as an emergency medical facility.

FIG. 11 is side view of the container of FIG. 10 where a walkway and counterweight are at least partially extended from the container.

FIG. 12 is a side view of a vehicle used to transport the container of FIG. 10.

### DETAILED DESCRIPTION

Referring now to FIGS. 1-4, a firefighting system of the present invention is illustrated where the firefighting system includes a container or pod 100 which is designed to hold water or a suitable fire suppressant that can be transported to a high rise fire or other high places such as by helicopter to help reduce and eliminate a fire in a high rise building. The firefighting system therefore enables firefighters to better combat fires in high rise buildings and significantly reduce the loss of life and damage caused by these fires.

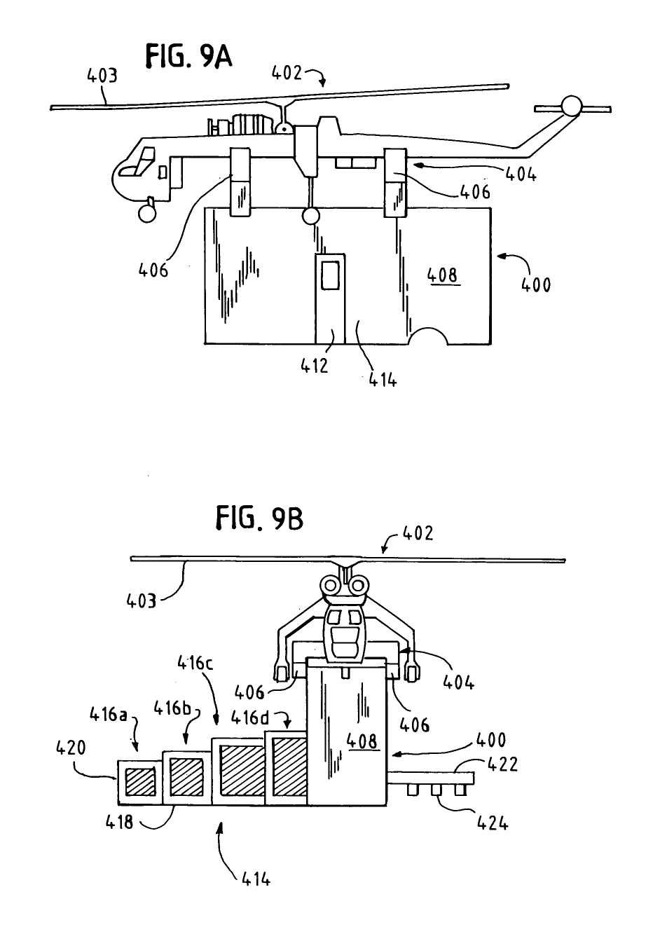

The firefighting system shown in FIG. 1 includes a container or pod 100 of fire-fighting foam, water or other suitable fire suppressant, attached to a multi-purpose lift or securing mechanism 104, which is attached to a transporter such as helicopter 102. It should be appreciated that the transporter or helicopter may be any suitable helicopter such as helicopters 102 and 402 in FIGS. 1 and 9A, respectively, or any suitable air transporter or air transportation vehicle. In the illustrated embodiment, when the helicopter latches on to the multi-purpose securing mechanism, a power connection is automatically coupled to a suitable electric power source such as an electric generator on the helicopter. The power source provides power for the systems on the container.

In the illustrated embodiment, the container or pod 100 includes a housing 108 that is generally rectangular in shape having a base or bottom portion 116 and four side walls 112 which extend generally upwardly from the base 116. A top wall or top surface 114 is attached to the top edges or top surfaces of each of the side walls opposite to the base 116. The base 116, four side walls 112 and top wall 114 form the housing and define an interior space or receptacle for receiving and storing a fire suppressant such as water or other suitable fire suppressant.

As shown in FIG. 1, the container or pod 100 is latched to a container of fire-fighting foam, water or other suitable suppressant. The container also contains an extendable water cannon. The inlet to the water cannon is automatically coupled to the foam container when the attachment is latched to the foam container. The extendable water cannon can be extended as required and can be adjusted in elevation and/or azimuth as required to direct the foam stream effectively to the fire. Suitable actuators powered by the attachment electrical system provide the required motions for extension, elevation, and azimuth corrections. These motions are controlled by an operator in the helicopter who uses an on-board electronic system to control the functions of the helicopter and the container.

The on-board electronic system contains electronic sensors such as force transducers, accelerometers, gyroscopic devices and other suitable sensors. These devices are in communication with the electronic system and provide stability correction signals to the helicopter flight control system to counteract the destabilizing effects of changes in center of gravity due to the emptying of the container, extending and aiming the water cannon, reaction to the thrust of the foam stream, wind forces on the container, and other destabilizing influences.

The containers described above can be pre-positioned at suitable locations so that the helicopter can be deployed quickly to latch on to a container and attack the fire. While the helicopter is fighting the fire with the first container, other containers from land-based storage areas can be brought to the scene by truck or other means so that a continuous supply of foam containers is available to fight the fire. If the land-based containers do not arrive quickly enough, the helicopter can retrieve another container from one of the pre-positioned locations. Since most helicopters have speeds in excess of 100 miles per hour, the retrieval of additional containers from pre-positioned locations can be accomplished quickly.

A plurality of latch members or latches 126 are securely connected to the housing 108. The latches 126 may be welded onto the housing, integrally formed with the housing or secured to the housing in any suitable manner. Each latch 126 includes an upper receptacle 128 and a lower receptacle 130. The upper receptacle 128 is defined by or formed in the latch 126 and has a generally triangular shape. The lower receptacle 130 has a generally rectangular shape and is defined by or formed in latch 126 and positioned below the upper receptacle 128. The upper and lower receptacles 128 and 130 defined by each of the latches 126 are adapted to engage and be securely held by a securing mechanism 104 as illustrated in FIG. 1.

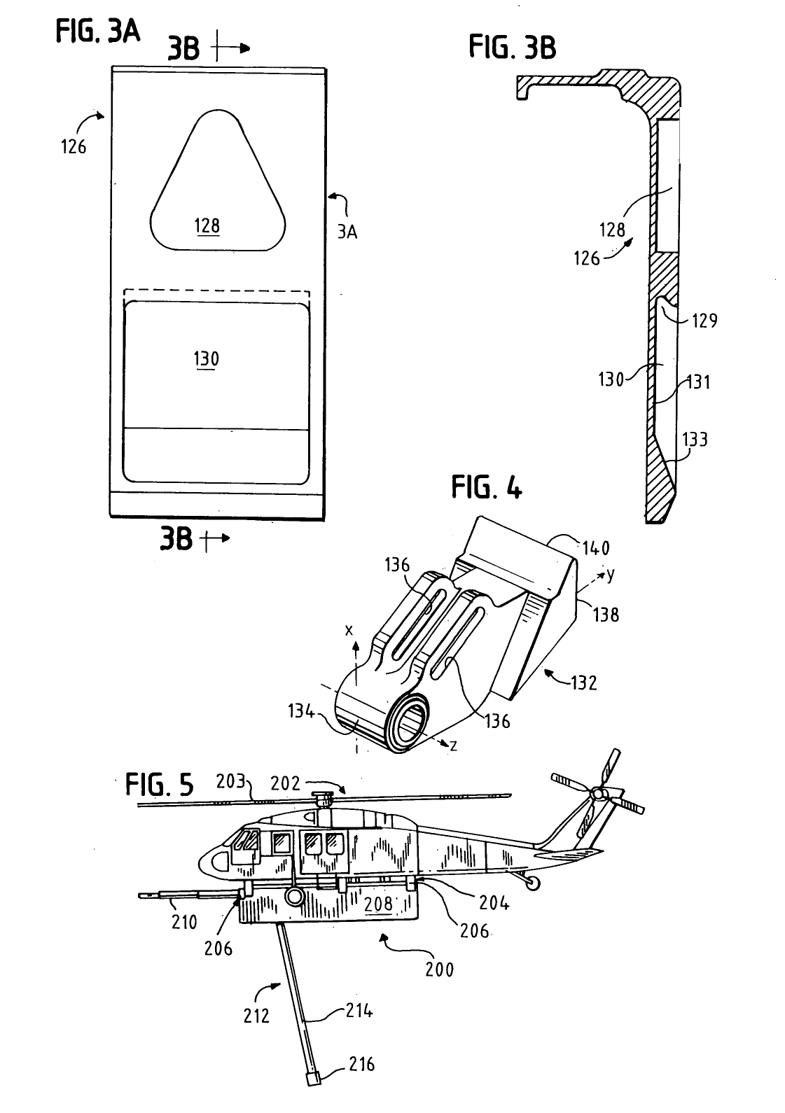

The securing mechanism 104 can be any suitable mechanism such as the securing mechanism or lift described by U.S. Pat. No. 5,573,293, assigned to Mi-Jack Products, Inc., which is incorporated herein by reference. The securing mechanism 104 includes four lift devices or securing devices 132 which correspond in position to each of the latches 126 on the housing 128. As shown in FIGS. 3A, 3B and 4, the securing devices 132 include a first end 134 which defines a circular opening or channel. The opening or channel is sized to engage a corresponding post or pole of the securing mechanism 104. The opening or channel on first end 134 thereby enables the securing device to pivot about the post and be adjusted to securely engage the lower receptacle 130 of each of the latches. Securing device 132 also defines elongated openings or slots 136 which help support the securing device and enable the position of the securing device to be adjusted as needed. A second end 138 of the securing device, which is opposite to the first end 134, includes at least one hook member or hook 140. The hook member or hook 140 includes a generally angular surface which is sized to engage the lower receptacle 130 of each of the latches 126. It should be appreciated that any suitable securing device or devices may be used to engage and securing the containers 100.

Referring now to FIGS. 3A and 4, each securing device 132 is positioned to correspond to the positions of the latches 126 on the containers or pods 100. When the securing devices are positioned or moved adjacent to the latches, the positions of the securing devices 132 are adjusted as necessary to align and engage the securing devices with the lower receptacles 130 of the latches. The securing devices engage the lower receptacles 130 of each latch 126 and, more specifically, the hook 140 of each securing device engages and pushes upwardly on indent 140 of the lower receptacle 130 of each latch. The engaging action or upward force of the hook 140 against the indent of each of the latches 126 enables a transport device such as a helicopter to engage the container and upwardly support the container or pod 100.

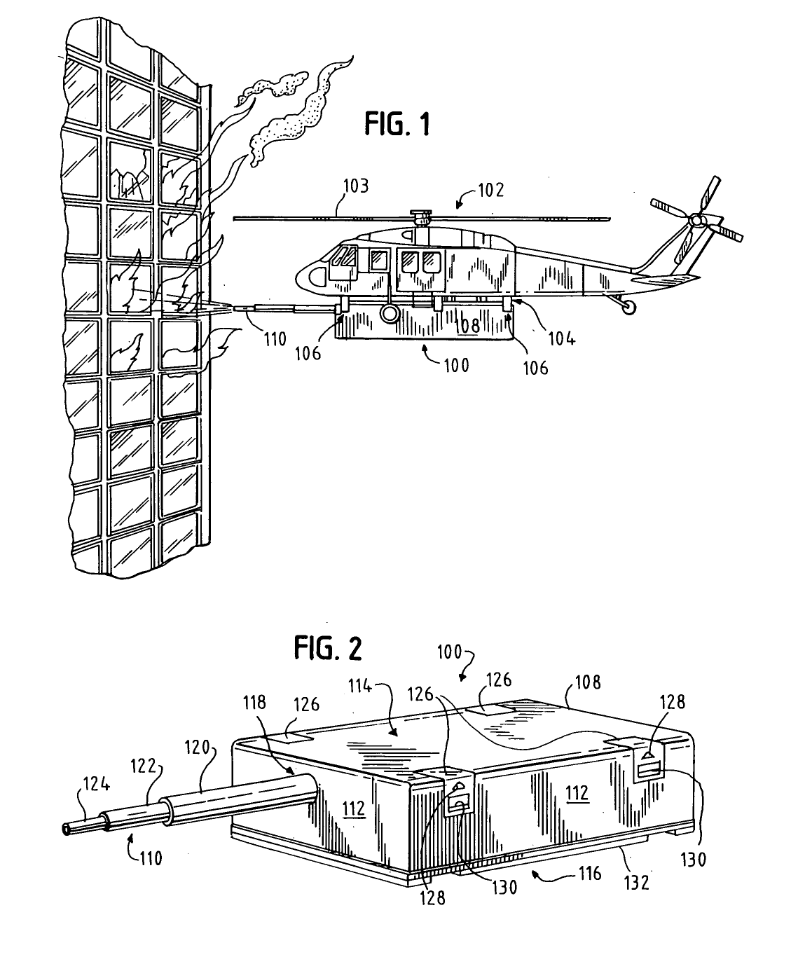

In the illustrated embodiment shown in FIGS. 1 and 2, the container or pod 100 includes an extendable nozzle or a cannon 110. The extendable cannon 110 includes a plurality of sections or tubes such as first tube 120, second tube 122, and third tube 124. The third tube 124 slidingly engages second tube 122 and are adapted to each be slidingly engaged with or received by first tube 120. The three tubes, and specifically the first tube 120, are slidingly engaged with an opening 118 defined by the housing 108 of the container or pod 100. Therefore during transport or non-use, the first, second and third sections or tubes 120, 122 and 124, respectively, of the extendable cannon 110 are retracted or moved within housing 108. An electrical connector such as suitable wiring cable or other suitable connector, is attached between the securing mechanism 104 and the container or pod 100. The electrical connection is made when the pod is initially picked up by a helicopter or other airborne device. It should be appreciated that the electrical connection between the container and the securing mechanism may be performed manually or automatically.

In the illustrated embodiment, the helicopter pilot or other member of the crew activates a button or switch to cause the extendable cannon to move outwardly away from the housing 108. After the cannon 110 is fully extended, the pilot activates the same or a different button or switch to cause the cannon 110 to emit a continuous stream of water or other fire suppressant at a designated rate and pressure. It should be appreciated that any suitable rate, pressure or pressures may be employed to emit the water or fire suppressant from the extendable cannon 110. It should also be appreciated that the cannon 110 may be any suitable size or shape or have any suitable number of sections or tubes that slidingly engage within each other to form the cannon. As illustrated in FIG. 1, the container or pod 100 is secured by securing mechanism 104 and secured to the bottom of an air transport vehicle such as a helicopter 102 having blades or rotors 103. The containers 100 can be pre-positioned at suitable locations so that the helicopter can be deployed quickly to latch on to a container and attack the fire. While the helicopter is fighting the fire with the first container, other containers such as those used for land-based storage areas can be brought to the scene by truck so that a continuous supply of fire suppressant or foam containers is available to fight the fire. If the land-based containers to not arrive quickly enough, the helicopter can retrieve another container from one of the pre-positioned locations. Since most helicopters have speeds in excess of 100 mph, the retrieval of additional containers from pre-positioned locations can be accomplished quickly.

In the illustrated embodiment, the container or pod 100 is positioned beneath the helicopter 102 to enable the helicopter to freely move from side to side or forward or backward as needed. The container or pod 100 is also positioned and connected to the bottom of the helicopter opposite to the blades and rotors 103 so that the pod 108 will not interfere with the blades or rotors 103 or any other portions of the helicopter. FIG. 1 illustrates how a continuous stream of water or fire suppressant under a designated pressure is emitted or discharged from the water cannon 110 toward a fire in a high rise building or other high area. The container or pod 100 therefore enables users such as firefighters to quickly reach a fire in a high rise building or other high area and direct water or any other suitable fire suppressant from an airborne vehicle such as a helicopter onto the fire. The container 100 also enables firefighters to be able to combat fires in high rise buildings by gaining external access to those areas where such access was not previously available.

Referring now to FIG. 5, another embodiment or variation of the fire-fighting system of the present invention is illustrated. In this embodiment, a detachable water tank or container 200 is attached to the multi-purpose securing mechanism or attachment device 204. The attachment means and coupling devices are as previously described.

The container 200 includes a housing 208 having a bottom wall and four side walls extending generally upwardly from the bottom wall and a top wall as shown previously in FIG. 2. The housing is connected to a securing mechanism 204 using connectors 206 as described above. The container includes a water cannon 210 that emits water or other suitable fire suppressants from the housing 208.

A re-fill snorkel or suction device 212 is connected to the bottom wall or bottom surface of the housing 208. The suction device 212 can be any suitable suction device or devices. The suction device 212 includes a shaft 214 which may be rigid or flexible, such as a hose, and a nozzle 216 secured to one end of the shaft 214. The other end of the shaft 214 is securely connected to the bottom of the housing 208. The suction device or snorkel is attached to a motor or other suitable actuator in the housing 208 to generate a vacuum or suction like effect through the nozzle 216 and the shaft 214. The suction through the shaft and therefore the nozzle 216 enables the suction device to be able to suck up a liquid such as water or other fluid to the housing 208 after the shaft 214 and nozzle 216 are at least partially submerged in a liquid such as water or other suitable fire suppressant.

The container 200 can therefore be refilled by having the helicopter hover over a water source such as a pond, river, lake or similar body of water and submerging the snorkel below the water surface. Water or a mixture of water and foam from an on-board foam container (not shown) can be directed to the fire by the extendable water cannon as described above. Additionally, a bottom-drop door (not shown) is provided so that the container contents can be dropped directly onto a fire if there is a need to do so such as with a roof fire.

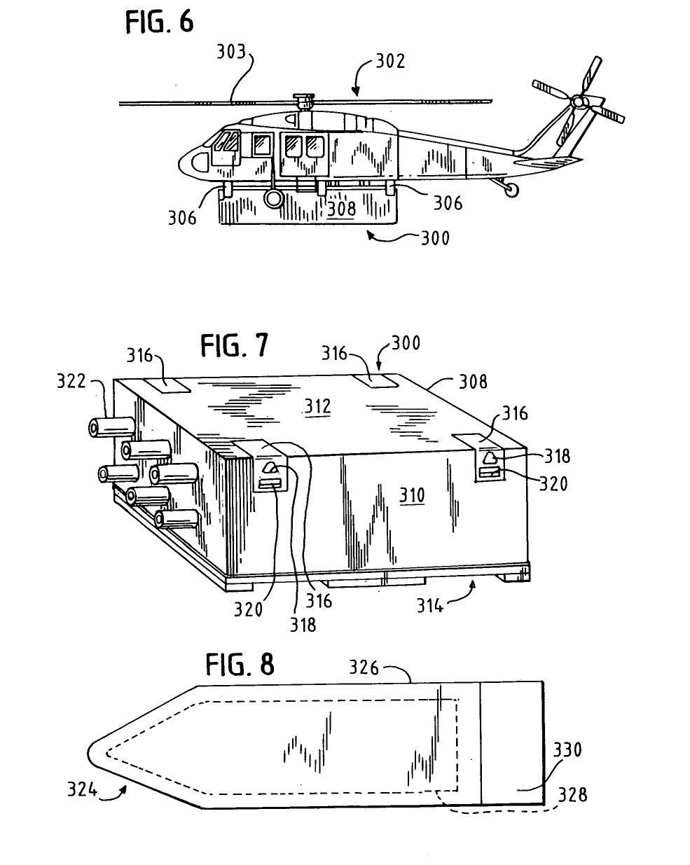

Referring now to FIGS. 6 and 7, a further embodiment of the firefighting system is illustrated. In this embodiment, a container 300 is configured to direct or project halon shells or canisters 326, or canisters including other suitable oxygen depletion or flame retardant substances, into a fire to help control and extinguish the fire.

In this embodiment, the firefighting system includes a container or pod 300 having a generally rectangular shaped housing 308. The housing 308 includes a bottom wall and side walls which extend generally upwardly from the bottom wall. A top wall or top surface is connected to the top edges of the four side walls to form the housing and define an interior space or receptacle. The housing 308 includes a plurality of connectors or latches 306 which engage hook members or hooks 132 as described above of a securing mechanism 304 which secures the container or pod 300 to the bottom of a helicopter 302 to securely hold the container or pod 300.

The housing 308 defines at least one and preferably a plurality of ejector channels, tunnels or tubes 322. In an embodiment, the ejector tubes 322 automatically extend from the container based on a control input from a pilot or other operator. The ejector tubes 322 may be any suitable size or shape. In the illustrated embodiment, the ejector tubes 322 are sized to hold and eject the shells or canisters 326 as shown in FIG. 8. Each ejector tube 322 may eject one or more of the canisters 326. Generally, each of the ejector tubes 322 and the housing 308 are sized to store a plurality of canisters 324 but also to maintain the housing 308 of the container or pod at a suitable size and shape to be air secured or moved by an airborne vehicle such as a helicopter.

In another embodiment, the container 300 includes an extendable cannon (not shown) which includes one or more stages or sections and is automatically extended from the container. The cannon is extended and moved as required in elevation and azimuth as described above.

Referring now to FIG. 8, in one embodiment, each canister 324 includes a housing 326 having generally angled or beveled front surfaces defining an interior chamber, receptacle or space which holds a fire suppressant such as halon gas or other suitable type of fire suppressing gas or liquid. The halon shells are launched to the fire target area by explosive charge, compressed air or any other suitable method. In one embodiment, a solid propellant 330 is connected to each of the canisters 324 to enable the canisters to be ejected or emitted from each of the ejection tubes 322 and toward at least a portion of a fire in a high rise building or other high location. Specifically, each canister is ejected from the container at a designated rate and pressure. It should be appreciated that the canisters may be ejected at any suitable rate and pressure.

The canisters 324 open and release the contents held inside the canister upon impact with the building. The shells are launched with sufficient force to penetrate windows or relatively thin walls. In another embodiment, the shells include a timer or timing mechanism where the contents of the shells are released after a designated or predetermined amount of time as set in the timer. A fire suppressant such as halon gas significantly reduces and/or eliminates a fire or fires. It should be appreciated that the canisters 324 may be any suitable size or shape. It should also be appreciated that the solid propellant 330 may be any suitable propellant for causing the canister 324 to be emitted or ejected from the ejection tubes 322.

Referring to FIG. 7, in one embodiment, the channels or tubes 322 are generally circularly shaped and mounted to be initially flush with the front surface of the housing 308. The tubes 322 are extendable and automatically extend from the container when an operator such as the pilot of the helicopter activates an input or button from inside the helicopter. It should be appreciated that one or more extendable cannons or tubes 322 may be connected to the container. Each tube or cannon 322 includes one or more sections which are extendable from the container 300. A plurality of latches 316 are attached to the top wall 312 and side walls 310 using a suitable connector or connectors. As described above, the securing mechanism 304 causes each of the securing devices 132 to engage the latches 316 and secure the container or pod 300 off of the ground by a helicopter which remotely controls the emission or ejection of the water, fire suppressant, or other suitable chemical or materials from the container.

Referring now to FIGS. 9A and 9B, another embodiment of the firefighting system of the present invention is illustrated. This system includes, a container 400 having an extendable rescue platform or bridge 414 which is deployed to allow people to escape from a fire by walking on the platform to the helicopter. In order to maintain stability, a system of force sensors are used to calculate the moment caused by extending the rescue platform. The on-board electronic system automatically extends a counter weight to maintain balance and stability as described below. When a person is walking on the platform, the platform, the sensors, and electronic system automatically position a second or secondary extendable counterweight to maintain stability and balance.

In the illustrated embodiment, the container or pod 400 has a generally rectangular shape and is sized to hold one or more people. The container or pod 400 includes a housing 408 which is generally rectangular in shape and defines a room or area having a suitable height to accommodate people. As illustrated, the container or pod 400 includes latches 406 which connect with the securing mechanism 404 to enable the container or pod 400 to be lifted up underneath the helicopter 402 to be moved or transported to a designated area. In the illustrated embodiment, the housing 408 includes at least one door 412. The door 412 is movably or hingedly connected to the housing 408 and swings open to the left or to the right depending on the preferences of the manufacturer. It should be appreciated that the housing 408 may be sized to any suitable size or shape, depending on the particular application. For example, different sized containers or pods 400 may be made to accommodate different numbers of people. It should also be appreciated that the door may be slidably connected to the housing or connected in any suitable manner.

In the illustrated embodiment, an extendable walkway 414 is contained within the housing 408 and is automatically extended away from the housing 408 toward a high rise building or other location to attempt to rescue one or more people trapped in the high rise building. The extendable walkway 414 includes sections, ramp members or stages 416a, 416b, 416c and 416d which automatically extend toward and away from a side of the housing 408 and forms the extendable walkway 414 when a control or an input such as a button is activated by an operator in the helicopter. Each ramp member or stage 416 includes a platform or walking surface 418 made of a suitable metal or other suitable material. Additionally, each ramp member or stage 416 includes a handrail or rail 420. The rails 420 provide a surface for a person escaping a fire to hold onto and helps that person to stably move along the walkway to get to the housing 408. It should be appreciated that the extendable walkway 414 may include any suitable number of ramp members or ramp stages 416. It should also be appreciated that the extendable walkway 414 can extend to any suitable distance and does not necessarily have to be fully extended to be operational or usable. It should be further appreciated that the extendable walkway may extend from either side of the container or from the front or back of the container as shown in FIG. 11.

At least one counterweight such as first counterweight 422 extends outwardly away from the housing 408 on a side opposite to the side including the extendable walkway 414. The counterweight 422 automatically extends toward and away from the housing as necessary to counter the weight or rotational force or torque generated by the walkway 414, which depends on the distance that the walkway is extended from the housing 408. The first counterweight 422 is extended outwardly away from the housing 408 based on the distance that the walkway 414 is extended from the housing. Additionally, one or more second counterweights 424 are attached or connected to the first counterweight 422 to provide additional weight or counterweights for the walkway 414 as needed.

In operation, the helicopter operator, who is sitting within the helicopter 402, positions the helicopter so that the securing mechanism can grasp or latch onto the container or pod 400 which is positioned on the ground or on top of a nearby building or buildings. The securing mechanism secures the container or pod and the helicopter 402 engages, lifts and secures the container or pod 400 to carry it to a location on a high rise building which is on fire or that has people who are trapped and need a way out. The helicopter operator uses controls connected within the helicopter 402 that send electrical signals to the extendable walkway 414 and first and second counterweights 422 and 424 to automatically extend away from the housing 408 a designated or desired distance. Once extended to the designated or desired distance, the helicopter operator positions the helicopter 402 close to where the people are trapped in the high rise building to attempt to rescue those people. The helicopter operator positions the extended walkway as close to the building as possible to enable the trapped people to access the walkway 414 and use the walkway to enter the housing 408 of the container or pod 400.

In one embodiment, one or more sensors or sensing devices such as position sensors are connected to and positioned on or near the front of the helicopter 402. Each position sensor is calibrated to provide a warning signal to the helicopter operator or pilot that the distance between the rotor tip and a fixed obstruction such as a building, utility tower or the like is approaching a minimum safe value. The minimum safe value may be a pre-programmed or pre-determined fixed value or may be automatically adjustable to compensate for such factors as wind velocity, voltage, or power lines or other criteria. It should be appreciate that any suitable sensor or sensors may be used to identify the position of the rotors and/or helicopter.

In another embodiment, the extendable rescue walkway or platform may also be equipped with an extendable canopy (not shown) to protect people on the platform from water spray, falling debris such as fragments of broken glass from windows or ashes.

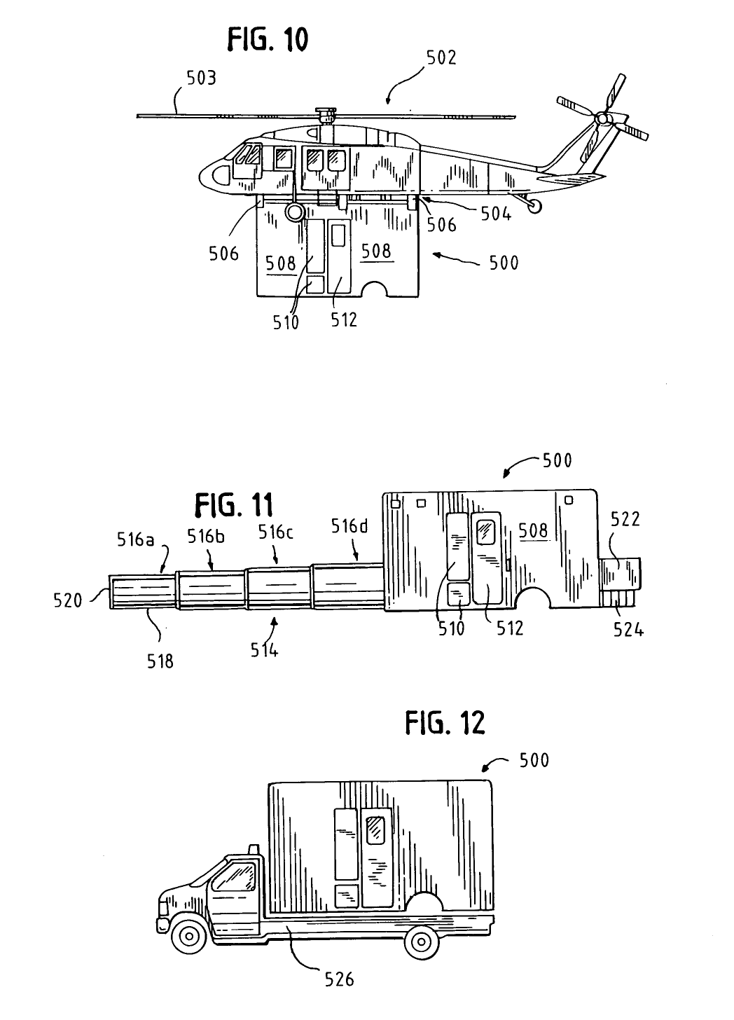

Referring now to FIGS. 10, 11 and 12, in a further embodiment, the container 500 is set up as an emergency rescue pod that is installed on a helicopter 502. The lifting attachment or lift mechanism 504 latches on to the helicopter, and the emergency rescue pod or container 500 is latched to the lifting mechanism using latches 506. The container 500 is automatically coupled to a suitable power source such as a generator on the helicopter. The latching devices or latches 506 utilized by the lifting attachment or device 504 to latch to the helicopter and the container or emergency rescue pod 500 may be the Mi-Jack wedge described above or any other suitable devices.

In this embodiment, the emergency rescue pod or container 500 including a housing 508 which is equipped with first aid and life support equipment such as found in a typical paramedic emergency van. Also, the emergency rescue pod is equipped with an extendable platform 514 as described above to allow fire victims to enter or be assisted to enter the emergency rescue pod. Additionally, emergency personnel such as firefighters, paramedics and other people can be transported to a particular part of a building or other high location in the container 500 and then use the walkway or platform to access the building.

In one embodiment, the container or pod 500 includes panels 510 which securely support and conceal the electrical controls for the housing 508 as well as other controls. In the illustrated embodiment, the housing 508 includes at least one door 512. The door 512 is movably connected to the housing 508 and swings open to the left or to the right depending on the preferences of the manufacturer.

In order to maintain stability, a system of force sensors is used to calculate the moment caused by extending the platform. First or primary counterweights and second or secondary counterweights 522 and 524 are extended on an opposite side to the platform 514 to maintain stability as described above.

After one or more people are rescued from the high rise building and are safely inside the container or pod 500, the helicopter operator transfers the container or pod 500 to the ground so that the trapped people can be treated by medical staff. Alternatively as described above, doctors, nurses and other medical personnel may be transported inside the container or pod 500 to the fire location to immediately treat fire victims as they enter the housing 508.

Once on the ground, the entire container may be placed on a truck chassis or other vehicle by the helicopter so that the emergency rescue pod may be driven to a hospital or emergency care facility in the same way as a paramedic rescue van would be driven to such locations. In the illustrated embodiment, the helicopter 502 positions or places the container or pod 500 onto a suitable moving vehicle such as a truck 526. The housing 508 of the container or pod 500 is securely attached and/or positioned on the truck. The truck 526 can then transport the container or pod 500 directly to a hospital or other emergency care facility so that the people inside the housing, which were rescued from the high rise building, can be treated immediately. It should be appreciated that the truck 526 may be any suitable vehicle or vehicles for transporting the container.

The above embodiments describe a multi-facet fire fighting system in which various special purpose subsystems can be mounted on a helicopter or other transportation vehicle. Although the subsystems form a fire fighting system particularly suitable to fighting urban high-rise fires, it should be appreciated that the present invention is not limited to such a use and may be used for other suitable purposes.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A firefighting system comprising:
a helicopter;
a securing mechanism connected to the helicopter;
a housing defining a receptacle for storing a fire suppressant material, said housing including a plurality of securing devices, each of said securing devices being engageable by said securing mechanism to secure said housing to said helicopter for transport to a location of a fire; and
at least one cannon connected to said housing, said cannon being automatically extendable from said housing and operable to emit at least a portion of the fire suppressant material on the fire.

2. The system of claim 1, wherein said cannon includes a plurality of telescoping sections to provide the extendability feature of said cannon.

3. The system of claim 1, wherein the cannon is automatically coupled to said housing when said housing is connected to said helicopter.

4. The system of claim 1, wherein the fire suppressant material includes at least one of the materials selected from the group consisting of: water and halon gas.

5. The system of claim 1, which includes a suction device connected to said housing, said suction device operable to transport a fire suppressant material from a source of said fire suppressant material to said housing.

6. The system of claim 1, which includes a door movably connected to a bottom surface of said housing, wherein said door is operable to move between a closed position and a substantially open position to enable the fire suppressant material stored in said housing to be dropped onto the fire.

7. The system of claim 1, wherein the helicopter includes at least one actuator in communication with said housing, said actuator operable to adjust at least one of the extension, elevation and azimuth of said cannon.

8. The system of claim 1, which includes at least one sensor connected to the helicopter, said sensor operable to determine a plurality of operational parameters associated with said helicopter, said sensor including at least one of the sensors selected from the group consisting of: a force transducer, an accelerometer and a gyroscopic device.

9. The system of claim 1, which includes a plurality of housings, each of said housings defining a receptacle for storing a fire suppressant material and being engageable by said securing mechanism to interchangeably secure each of said housings to said helicopter for transport to the location of the fire.

10. A firefighting system comprising:
a helicopter;
a securing mechanism connected to said helicopter;
a housing including a cannon, said housing including a plurality of securing devices, each of said securing devices being engageable by said securing mechanism to secure said housing to said helicopter for transport to a location of a fire; and
at least one canister stored in said housing, said canister including a fire suppressant material, wherein said cannon is operable to eject said canister from said housing to the location of the fire.

11. The system of claim 10, wherein said housing includes a plurality of cannons, each of said cannons operable to eject one of a plurality of canisters stored in said housing.

12. The system of claim 10, which includes a solid propellant connected to said canister to propel said canister from said housing via said cannon.

13. The system of claim 10, wherein said cannon includes a plurality of telescoping sections to provide the extendability feature of said cannon.

14. The system of claim 10, wherein the helicopter includes at least one actuator in communication with said housing, said actuator operable to adjust at least one of the extension, elevation and azimuth of each of said cannons.

15. The system of claim 10, which includes a plurality of housings, each of said housings including at least one extendable cannon and a plurality of canisters containing a fire suppressant material, wherein said housings are each engageable by said securing mechanism to interchangeably secure each of said housings to said helicopter for transport to the location of the fire.

16. A firefighting system comprising:
a helicopter;
a securing mechanism connected to said helicopter;
a housing adapted to hold at least one person, said housing including a plurality of securing devices, each of said securing devices being engageable by said securing mechanism to secure said housing to said helicopter for transport to a location of a fire;
at least one door movably connected to said housing to enable the person to access said housing; and
a ramp connected to said housing, said ramp being positioned adjacent to said door and operable to automatically extend from said housing to enable the person to move from the location of the fire to the housing, wherein said ramp is constructed to support the weight of the person.

17. The system of claim 16, wherein said ramp includes a plurality of telescoping sections, each of said sections including a platform and a handrail to provide support for the person moving from the location of the fire to said housing.

18. Thee system of claim 16 which includes at least one counterweight connected to the housing, said counterweight being automatically extendable from a side of said housing opposite to said side including said ramp to counteract a moment generated by the weights of the person and the ramp.

19. The system of claim 16, wherein said housing is adapted to hold a plurality of people, and wherein said ramp is constructed to support at least the combined weight of said people moving on said ramp from the location of the fire to said housing.

20. The system of claim 16, which includes at least a first counterweight movably connected to said housing, wherein said first counterweight is operable to automatically extend a distance from said housing to counteract a moment generated by the combined weight of said ramp and the person.

21. The system of claim 20, which includes a second counterweight connected to one of said housing and said first counterweight to counteract the moment generated by the combined weight of the said ramp and the person.

22. The system of claim 20, which includes at least one force sensor connected to said helicopter, said force sensor operable to calculate the moment created by the weight of said ramp and the person, wherein said first counterweight is automatically extended from said housing based on the moment calculated by said sensor.

23. The system of claim 16, which includes an extendable canopy connected to said ramp, said canopy adapted to protect the person moving on said ramp from falling debris generated by the fire.

24. The system of claim 16, wherein said housing includes emergency medical equipment used to treat a person injured by the fire.

25. The system of claim 16, which includes at least one generator coupled to said helicopter, said generator operable to generate electricity for said housing, said housing being automatically coupled to said generator when said housing is connected to said helicopter.

26. The system of claim 16, wherein said housing is adapted to be secured to a truck to transport any injured people to an emergency medical facility.

27. A method of operating a firefighting system comprising:
(a) securing a container to a helicopter having a securing mechanism and at least one control mechanism, said container including a plurality of securing devices, each of said securing devices being engageable by said securing mechanism to secure said housing to said helicopter for transport to a location of a fire;
(b) automatically coupling said control mechanism to said container, said control mechanism operable to communicate with said container and control a function of said container; and
(c) transporting said container to a location of a fire.

28. The method of claim 27, wherein the function includes automatically extending a cannon connected to said housing, said cannon operable to emit a fire suppressant material stored in said container on the fire.

29. The method of claim 27, wherein the function includes ejecting a canister containing a fire suppressant material from a cannon connected to the container to the location of the fire.

30. The method of claim 27, wherein the function includes automatically extending a walkway movably connected to said housing, said housing adapted to hold at least one person, wherein said walkway is adapted to support the weight of the person.

31. The method of claim 30, which includes automatically extending a first counterweight from a side opposite to said side of said housing including said walkway, said first counterweight being automatically extended from said housing based on a distance said walkway is extended from said housing.

32. The method of claim 31, which includes automatically extending a second counterweight from said housing based on the distance that said first counterweight and said walkway are extended from said housing.
